(19) United States
(12) Patent Application Publication
(10) Pub. No.: US 2026/0339771 A1
(43) Pub. Date: Oct. 29, 2026

(54) TECHNIQUES FOR PROACTIVE AUTOMATIC PROGRAM REPAIR INTEGRATED INTO CODE REVIEW SYSTEM USING LARGE LANGUAGE MODELS

(71) Applicant: SAP SE, Walldorf (DE)

(72) Inventors: Jingun Hong, Bundang-gu (KR); Hyun Deok Choi, Seoul (KR); Chansong You, Seoul (KR); Ji Young Kim, Seoul (KR)

(21) Appl. No.: 19/189,871

(22) Filed: Apr. 25, 2025

(51) Int. Cl. G06F 11/07; G06F 11/362

(52) U.S. Cl. CPC G06F 11/0793; G06F 11/362

(57) ABSTRACT

In some implementations, techniques can include detecting a fault for a program by analyzing received data. The techniques can include determining a location of the fault in program code via one or more localization techniques. The techniques can include generating a patch for the fault. The techniques can include validating the patch using one or more validation procedures. The techniques can include displaying a user interface to receive developer feedback for the patch. The techniques can include receiving an input indicating the developer feedback for the patch. If the input indicates rejection of the patch, the techniques can include receiving developer feedback regarding the first patch and generating and validating another patch. The techniques can include performing a final review on the patch, generating, and storing a clean patch set.

### BACKGROUND

Automated Program Repair (APR) is one of the most challenging tasks in the field of software engineering. The goal of APR is to develop systems that can automatically fix software bugs without human intervention, which is considered an important aspect of software automation.

In practice, developers typically write code to implement a feature based on specified requirements. They also create test cases to verify the correctness of the implementation. If all tests pass, the feature can be considered to be working as intended. However, if some tests fail, developers need to investigate the causes of the failures and modify the buggy code until all tests pass the test.

More formally, APR aims to find the minimal transformation P′ of a buggy program P such that P′ satisfies the specification S, which P fails to meet. In most cases, the test suite serves as the specification. The standard APR workflow consists of three main stages. The first stage can consist of fault localization. This stage can involve identifying the suspicious code elements that are likely responsible for the bug, using established localization techniques. The second stage can consist of patch generation. In this stage, modified versions of the program, known as “candidate patches,” that can be generated by applying various code transformations. The third stage can consist of patch validation. The candidate patches can be evaluated using the available test suite. If a patch passes all the tests, it is considered a “plausible” patch.

However, a plausible patch may not necessarily represent a genuine fix for the bug. If the patch fails when subjected to additional tests beyond the original set, it can be referred to as an “overfitting” patch, meaning it only works for the specific cases that were tested. Conversely, a truly “correct” patch can be one that remains effective under more comprehensive testing and aligns with the modifications a human developer would make to resolve the bug.

There has been growing interest in leveraging advanced large language models (LLMs) for APR, inspired by their success in natural language processing and software engineering tasks. Compared to earlier learning-based APR techniques, LL M-based methods have shown significantly improved performance and have garnered increasing attention within the research community. M any of the changes proposed on earlier learning-based APR techniques were not accepted by human developers. In addition, many of the human developer feedback could not be generalized using some kind of prompt or existing fine-tuning techniques.

Earlier learning-based APR techniques present several challenges. Current tools include passive systems that require explicit developer invocation. Most solutions operate outside the normal development environment that can result in workflow distribution. Excessive interactions between developers and AI systems can result in increased communication overhead. AI systems often lack necessary project specific context and therefore have context limitations.

This LLM-driven approach represents a promising direction in APR and is the focus of much current research. However, integrating LLM-based APR into the development workflow presents challenges. The fault localization results, and generated patches produced by LLMs should not overwhelm developers with constant notifications whenever an issue is detected, or a potential fix is generated. Instead, an asynchronous communication channel that seamlessly integrates into the developer's workflow is needed.

### SUMMARY

A system of one or more computers can be configured to perform particular operations or actions by virtue of having software, firmware, hardware, or a combination of them installed on the system that in operation causes the system to perform the actions. One or more computer programs can be configured to perform particular operations or actions by virtue of including instructions that, when executed by data processing apparatus, cause the apparatus to perform the actions.

One promising approach is to incorporate APR into the code review system. This allows developers to provide meaningful input to the LLM, guiding it towards better fault localization and patch generation. By integrating APR into the code review process, developers can review and validate the generated patches as part of their regular workflow, ensuring that the LLM's suggestions align with their understanding of the codebase and the desired fixes.

In one general aspect, the disclosed techniques can include detecting a fault for a program by analyzing received data. In various embodiments the received data comprises at least one of build logs, test results, crash reports, or execution logs.

The techniques can include determining the location of the fault in program code via one or more localization techniques. In various embodiments, the location of the fault is determined by one of more of: reviewing compiler warnings, localizing test failures, and parsing crash dumps to extract call stacks, register values, and memory information to identify null pointer references or failed assertions. In various embodiments, the localizing test failures can be accomplished via spectrum-based fault localization process.

The techniques can include generating a first patch for the fault. In various embodiments, the techniques for generating the first patch or the second patch can include using language server protocol features to collect context about the fault. The techniques for generating the first patch or the second patch can include extracting relevant code structures using tree-sitter parsing techniques. The techniques for generating the first patch or the second patch can include generating a fix using a large language model agent to analyze one or more of the context about the fault, the extracted relevant code structures, fault type, and relevant project-specific patterns.

The techniques can include validating the first patch using one or more validation procedures. The techniques can include displaying a user interface to receive developer feedback for the first patch. The techniques can include receiving a first input indicating the developer feedback for the first patch.

In various embodiments, the one or more validation procedures can include one or more of: reviewing language server protocol diagnostics, secondary test results, or secondary crash issues.

If the first input indicates rejection of the first patch, the techniques can include receiving developer feedback regarding the first patch. The techniques can include generating a second patch in view of the developer feedback regarding the first patch. The techniques can include validating the second patch using one or more validation procedures. The techniques can include displaying the user interface to receive developer feedback for the second patch. The techniques can include receiving second input indicating the developer feedback for the second patch.

If the first input or the second input indicates an approval of the first patch or the second patch, the techniques can include performing a final review on the first patch or the second patch. The techniques can include generating a clean patch set using the first patch or the second patch. The techniques can include storing the clean patch set.

In various embodiments, generating the clean patch set can include removing explanatory comments, verifying all temporary debugging code, to-do notes (TODOs), or non-production elements are removed, and conducting automated checks to ensure that the clean patch set maintains a consistent coding style, adheres to project conventions, and does not introduce new issues.

Implementation of the described techniques may be performed by a system including various hardware components, as a method or process, or stored as a series of instructions on a computer-readable tangible medium.

The following detailed description and accompanying drawings provide a better understanding of the nature and advantages of various embodiments of the present disclosure.

### BRIEF DESCRIPTION OF THE DRAWINGS

FIG. 1 illustrates an exemplary block diagram for a system for implementing the techniques described herein.

FIG. 2 illustrates an exemplary process diagram for proactive automatic program repair integrated into a code review system using large language models.

FIG. 3 illustrates a flowchart for an exemplary process for generating code for edge deployment.

FIG. 4 illustrates an exemplary special code block or code snippet.

FIG. 5 illustrates an exemplary user interface for a developer to preview a fix.

FIG. 6 a flowchart for proactive automatic program repair integrated into a code review system using large language models.

FIG. 7 illustrates an exemplary computer system for implementing various embodiments described above.

FIG. 8 illustrates an exemplary computing device for implementing various embodiments described above.

FIG. 9 illustrates an exemplary system for implementing various embodiments described above.

### DETAILED DESCRIPTION

In the following description, for purposes of explanation, numerous examples and specific details are set forth to provide a thorough understanding of the present disclosure. It will be evident, however, to one skilled in the art that various embodiments of the present disclosure as defined by the claims may include some or all of the features in these examples alone or in combination with other features described below and may further include modifications and equivalents of the features and concepts described herein.

In a proposed solution to integrate Automated Program Repair (APR) into the software development workflow, an artificial intelligence (AI)-based agent, built upon a large language model (LLM), plays a central role. This agent is designed to autonomously execute tasks using various tools, such as Language Server Protocol (LSP) features for code navigation, file editing, and file system navigation. A Language Server is meant to provide the language-specific smarts and communicate with development tools over a protocol that enables inter-process communication. The idea behind the Language Server Protocol (LSP) is to standardize the protocol for how such servers and development tools communicate. This way, a single Language Server can be re-used in multiple development tools, which in turn can support multiple languages with minimal effort.

The process can begin when a bug is detected through test failures, customer system issues, or other means, and is subsequently reported to a bug tracking system. The agent can monitor this system, identifying newly created bug reports. Upon detecting a new bug, the agent initiates a fault localization process that can include analyzing the symptoms, test outputs, crash dumps, and other relevant information provided in the bug report.

To localize the fault, the agent can employ code navigation features, such as “go to definition,” mimicking the actions of a human developer. The agent can explore the codebase, gathering insights and identifying potential locations of the fault. Once the agent has determined a candidate fault location, it can create a commit or pull request in the project's version control system (e.g., Gerrit or GitHub).

This commit can include comments above the problematic source code, detailing the reasoning behind the fault localization process and the insights gained. The agent then can add a comment to the bug report, providing a link to the commit and requesting the assigned developers to review the findings.

Developers can review the fault localization results and provide feedback on the reasoning process. If the feedback is negative, the agent can incorporate this information and performs the fault localization process again, refining its approach based on the developer's input. Once the change receives positive feedback, the agent can proceed to generate a fix for the bug.

To generate the fix, the agent can utilize language server protocol (LSP) features, such as “go to definition” or Linux commands such as “grep” search, along with file reading capabilities. The agent can apply the fix to the source code, documenting its reasoning process and the steps taken to generate the fix. The agent can verify the fix by ensuring that there are no build errors or test failures. If issues arise, the agent can address the issues using the error output, iterating until all tests pass successfully. Once the fix is validated, the agent can update the commit or pull request and adds a comment to the bug report, providing a link to the updated change.

In the disclosed techniques, developers can review the generated fix and provide feedback. If the feedback is negative, the agent uses this information to improve its fix generation process. If the changes are satisfactory, the developer can merge the commit or pull request or make manual adjustments before merging.

By integrating the agent into the code review system, developers can provide meaningful input throughout the fault localization and fix generation processes. This approach can ensure that the agent's suggestions align with the developers' understanding of the codebase and the desired fixes. The asynchronous communication channel, facilitated by the bug tracking system and version control platform, can allow for smooth and efficient integration of APR into the software development workflow.

Some target scenarios for using the disclosed techniques can include but are not limited to compiler warning fix, test failure fix, and crash issue fix. For compiler warning fixes, the AI agent can automatically identify and resolve compiler warnings like implicit data loss, deprecated declarations, and missing return statements before they accumulate and impact code quality. For text failure fixes, the system can monitor continuous integration pipelines, analyze test failures, localizes faults in the codebase, and generate appropriate fixes without requiring manual developer intervention. For crash issue fixes, the AI agent can process crash reports from production or quality assurance environments, traces through execution paths to identify root causes, and creates patches that prevent similar crashes in future releases.

In summary, the disclosed solution leverages an AI-based agent, built upon an LLM, to automate the fault localization and fix generation processes. By integrating the agent into the code review system and utilizing asynchronous communication channels, developers can provide feedback and guidance to the agent, ensuring that the generated patches are reviewed and validated as part of their regular workflow. This approach aims to seamlessly incorporate APR into the software development process, enhancing efficiency and reducing the burden on developers.

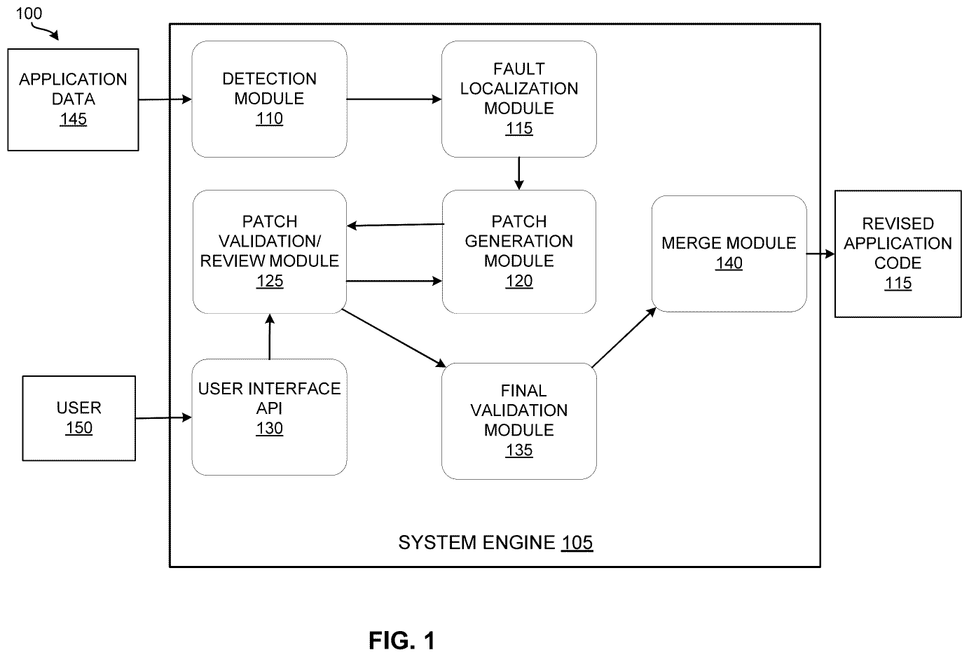

FIG. 1 illustrates an exemplary block diagram for a system 100 for implementing the techniques described herein. FIG. 1 illustrates a system engine 105 for proactive automatic program repair integrated into a code review system using large language models. The system engine 105 can include various modules that include one or more self-contained units of hardware or software that can perform a specific function within a larger system.

The system engine 105 can include a detection module 110, a fault localization module 115, a patch generation module 120, a patch validation and review module 125, a user interface API 130, a final validation module 135, and a merge module 140.

The detection module 110 can receive application data 145. The application data 145 can include one or more reports of test failures, customer service issues, bug or error reports, and/or computer logs. The detection module 110 can identify errors in application code using various techniques, depending on its purpose and implementation. The detection module 110 can detect errors through static analysis, dynamic analysis (during execution), machine learning-based detection, and formal verification. Static analysis can include syntax checking by ensuring correct syntax (e.g., missing semicolons, brackets). Static analysis can use linting tools that detect style issues and potential bugs (e.g., ESLint for JavaScript, Pylint for Python). Static analysis can include type checking that includes identifying type mismatches (e.g., TypeScript, MyPy for Python). Static analysis can include security scanning that can find vulnerabilities like SQL injection, XSS (e.g., SonarQube, Snyk).

Dynamic Analysis can include monitoring the application while it is running. Error logging and exception handling can capture runtime errors (e.g., logging frameworks like Log4j, Winston). Profiling and performance monitoring can detect memory leaks and inefficiencies (e.g., New Relic, Datadog). Fuzz testing can include feeding random or malformed inputs to find unexpected crashes.

Machine learning-based detection can use AI to predict and detect anomalies in the code. Anomaly detection can identify unusual patterns in execution logs. Code review automation can use A I-based tools like DeepCode or Codex analyze and suggest fixes. Predictive analysis can use historical data to prevent common mistakes.

Formal verification can use mathematical proofs to ensure code correctness.

In various embodiments, the detection module 110 can identify issues or software bugs using compiler warnings. The detection module 110 can monitor build logs to automatically detect and extract compiler warnings as soon as code changes are published.

In various embodiments, the detection module 110 can identify issues or software bugs using test failures. The detection module 110 can analyze continuous integration test results in real-time to identify test failures and their associated error messages.

In various embodiments, the detection module 110 can identify issues or software bugs using crash issues. The detection module 110 can analyze crash reports and execution logs from CI environments to capture runtime failures and exception stack traces.

A fault localization module 115 can detect the location in the lines of code where the issue or error exists.

In various embodiments, compiler warnings can pinpoint exact source code locations from build output diagnostics that include file paths, line numbers, and error codes.

In various embodiments, the fault localization module 115 can use spectrum-based fault localization in which test failures are analyzed to determine which code elements are covered by failing and passing various tests.

In various embodiments, crash issues can be tracked by parsing crash dumps to extract call stacks, register values, and memory information to identify null pointer references or failed assertions.

A patch generation module 120 can generate code changes or amendments to correct the identified issue, bug or error that was identified. In various embodiments, the patch generation module 120 can use language server protocol features like “go-to definition” definition, “find all references”, and “hover to collect context” features about the faulty code elements. In various embodiments, tree-sitter parsing can be used to extract relevant code structures such as function bodies, class definitions, and control flow blocks from the identified fault locations. In various embodiments, large language model agents can be used to generate appropriate fixes by analyzing the extracted code context, fault type, and relevant project-specific patterns.

Some exemplary language server protocol navigation tools can include go_to_definition(symbol) can jump to symbol definition location. The find_all_references(symbol) can find all usages of symbol across codebase. The get_quick_definition(symbol) can provide hover information for type/API details. The get_symbol_documentation(symbol) can retrieve documentation comments. The language server protocol navigation tools can be used to find location in code for certain code snippets.

Other Linux utilities can alternatively be used. Search and content access tools can include grep (pattern, file_pattern, options) or find so that provide searches codebase for matching patterns. The read (source_file, line_number, num_lines=100) features can read specific sections of files. These sets of tools can be provided to AI agent to navigate the code base and get more context from the code base to make possible patches to fix the identified issues.

Tree sitter is a language parser that supports many programming languages to include but not limited to C++, Go, Haskell, Java, JavaScript, Kotlin, Python, Rust, and Zig. Code structure analysis features can include Tree-sitter parses code at identified locations to extract function bodies, class definitions, control flow blocks, parent-child relationships between code elements, and type hierarchies and inheritance chains. Tree sitter can provide a uniform resource identifier (uri) and some range information (e.g., start and end) for certain functions.

Exploration phase tools can allow an agent to use go_to_definition to explore variable/function definitions. The find_all_references can help analyze how code elements are used elsewhere. The get_quick_definition can provide type information and API details.

Context gathering can allow an AI agent to use grep to find similar patterns or related code. This allows read retrieves additional code sections needed for context. The tree-sitter extracts precise AST structures from retrieved code.

Solution generation can allow an AI agent to analyze gathered information to understand root cause. The agent can generate patch based on code patterns, project conventions, and fault type. The agent can validate patch against expected behavior before submitting.

If the AI agent determines that more information is necessary to generate a patch because it lacks knowledge on how to correct the error, the AI agent can search other networks (e.g., the Internet) to find the necessary information. For example, if we ask the agent to get the weather in Paris today, the AI agent can use a tool (e.g., “get weather) to issue a function call to access the weather using a certain HTTP API or from a different website. The function call can be executed, and the returned value can be provided. In the case of code, the system can provide source file name and the function name or line number to an LLM, and the LLM can analyze the code to determine the location in the source code whether this information can be generated. Therefore, the AI agent can dynamically ask the required information and then conduct more research (e.g., a context search) to possible patches for the identified issue.

A patch validation and review module 125 can determine if the patch will resolve the issue or error without introducing new or additional errors. In various embodiments for compiler warning, the patch validation and review module 124 can use language server protocol (LSP) diagnostics to verify that warnings are resolved without introducing new build errors or additional warning. Test failures and crash issues can be validated by running previously failing tests against patched code, with iteration limits to prevent infinite loop attempts. In various embodiments, automated validation can be followed by human review to ensure that the fixes do not compromise feature requirements or simply rollback features.

The patch validation and review module 125 can receive inputs from one or more users 150 (e.g., developers) through a user interface API 130. The patch validation and review module 125 can receive and analyze comments from a user 150 for actional feedback, distinguishing between concrete suggestions and ambiguous responses such as “?” or statements such as “what do you think?” When feedback is unclear, an AI agent can generate clarifying questions that request specific direction on implementation approach or design preferences. Feedback evaluation logic can prevent patch generation cycles when input is insufficient, prioritizing meaningful engagement over repeated fix attempts.

A final validation module 135 can perform a review of accepted patches to remove explanatory comments that were included only to aid the code review process. AI agents can verify that all temporary debugging code, to-do (TODO) comments, or other non-production elements are removed before finalizing the patch. Final automated checks can ensure that the patch maintains consistent coding style, follows project conventions, and does not introduce new issues.

A merge module 140 can merge the accepted patches into the system code to generate a clean patch set after final validation and pushes it to the appropriate branch in the version control system. In various embodiments, auto-merge techniques can be triggered once all verification checks pass, with configurable safety thresholds that can require additional approval for critical components.

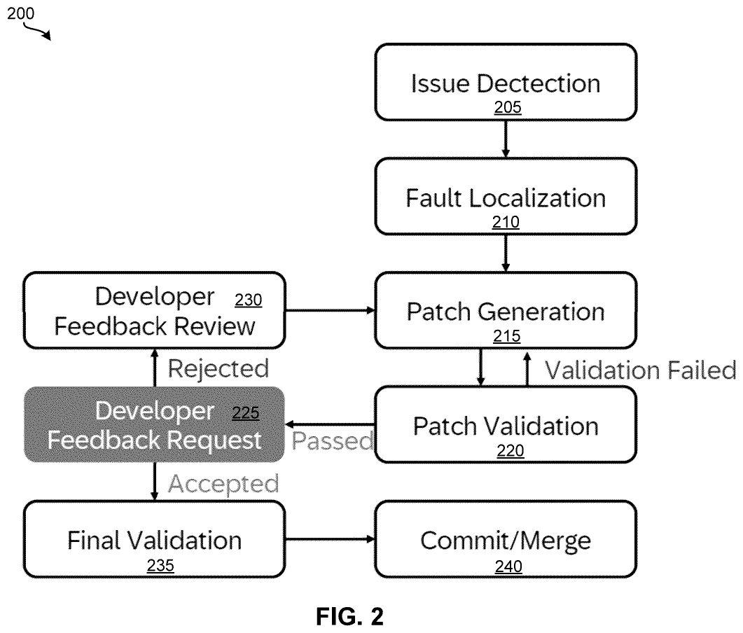

FIG. 2 illustrates an exemplary process diagram 200 for proactive automatic program repair integrated into a code review system using large language models.

At block 205, the detection module 110 (as shown in FIG. 1), can detect issues (e.g., software bugs) through test failures, customer system issues, or other means. The bug is reported to a bug tracking system. The AI-based agent, built upon a large language model (LLM), can monitor the bug tracking system. The agent can identify issues from newly created bug reports.

At block 210, the fault localization module 115 (shown in FIG. 1) can use an AI agent to initiate the fault localization process for a newly detected bug. The fault localization module 115 can determine the location in the software code base where there are some faults or root problems causing an error during code execution. The AI agent can analyze the symptoms, test outputs, crash dumps, and other relevant information provided in the bug report. The agent can use code navigation features, such as “go to definition,” to explore the codebase. Fault Localization 210 can be done using LSP diagnostics for compiler warnings. Fault Localization 210 can also be done using Spectrum-based Fault Localization in case of test failures in continuous integration (CI) pipeline. Fault Localization 210 can also be performed using an AI agent with parsed crash dump data and code navigation features for crash issues. In general, call stacks in crash dump contain file locations as entry points for further code search/navigation. The AI agent can gather insights and identify potential locations of the fault.

The AI agent can create a commit or pull request in the project's version control system (e.g., Gerrit or GitHub). In case of compiler warnings and test failures, the techniques do not need to create a new commit or pull request for the issues. However, in case of crash issues from a customer system there may not be a dedicated commit or pull request yet for the fix. Therefore, the techniques can create such a commit or pull request for a newly created bug, giving possibly root cause locations to developers. Still, this fault localization might provide wrong location, developer may correct this by providing additional information as a form of a code review comment. Developers can review the fault localization results and provide feedback on the reasoning process. If the feedback is negative, the agent incorporates the feedback and performs the fault localization process again, refining its approach.

In an example, in the event of test failures a developer can provide comments or code change suggestions. But those changes can result in other failures that did not occur prior to those changes. That could mean that these changes are the root cause of test failures. However, in larger software projects there are too many comments to pinpoint a single line or couple of lines that may be cause of issues. There is a narrowing approach to discover the code issues by starting from the initial location and then analyze and generate patches. At block 215, the patch generation module 120 (shown in FIG. 1) can generate a patch. Once the fault localization receives positive feedback, the AI agent proceeds to generate a fix for the bug. The AI agent utilizes LSP features, such as “go to definition” and “grep” search, along with file reading and editing capabilities. The AI agent applies the fix to the source code, documenting its reasoning process and the steps taken to generate the fix. For example, an exemplary compiler warning of “implicit-int-conversion” can be “TypeB bar=100; TypeA foo=bar.” The techniques would require type information on TypeA and TypeB so that the system can guarantee that there is no implicit data loss during type conversion. To know this, the AI agent may use either “go-to-definition” or “hover” LSP features to get the possible data ranges of both “TypeA” and “TypeB.”

At block 220, the patch validation and review module 125 (shown in FIG. 1) can validate the generate the fix by ensuring that there are no build errors or test failures. If issues arise, the AI agent addresses them using the error output, iterating until all tests pass successfully. If the validation fails, the AI agent can send the information from the validation stage to generate a second or subsequent patch.

At block 225, the patch validation and review module 125 (shown in FIG. 1) can receive developer feedback. Once the fix is validated, the AI agent can update the commit or pull request. The AI agent can add a comment to the bug report, providing a link to the updated change. Developer feedback often times can be arbitrary and unclear as to the specific nature of the suggestions or feedback. In those cases, the AI agent can ask probing questions to clarify the human developer specific questions to get details from the developer to help the system better understand the comments. This feedback process can be useful to reduce the number of patches from the developer. These further questions can shape the patch generation to provide better patches. The developer feedback is essentially preprocessed and can be used for patch generation.

At block 230, the patch validation and review module 125 (shown in FIG. 1) can receive developer feedback regarding the patch. Developers can review the generated fix and provide feedback through the UI API 130 as shown in FIG. 1. If the feedback is negative, the AI agent can use this information to improve the fix generation process. If the developer feedback is positive, the validated patch can proceed to final validation. At block 215, the feedback can be used to generate a second or subsequent patch.

At block 235, the final validation module 135 (shown in FIG. 1) can perform a review of accepted patches to remove explanatory comments that were included only to aid the code review process. AI agents can verify that all temporary debugging code, to-do (TODO) comments, or other non-production elements are removed before finalizing the patch. Final automated checks can ensure that the patch maintains consistent coding style, follows project conventions, and does not introduce new issues.

If the changes are satisfactory, the developer can merge the commit or pull request. Alternatively, the developer may make manual adjustments before merging.

At block 240, the merge module 140 (shown in FIG. 1) can merge the accepted patches into the system code to generate a clean patch set after final validation and pushes it to the appropriate branch in the version control system. For AI generated code, comments are often added to the lines of code for explanation. This can further increase the size of the code itself and after implemented, the comments may be undesirable. In various embodiments, auto-merge techniques can be triggered once all verification checks pass, with configurable safety thresholds that can require additional approval for critical components.

The AI agent can learn from the feedback provided by developers throughout the fault localization and fix generation processes. The AI agent can incorporate this feedback to improve its reasoning, fault localization, and fix generation capabilities over time.

The AI agent's actions can be seamlessly integrated into the development workflow through the code review system and asynchronous communication channels. Developers can provide input and guidance to the agent as part of their regular code review and bug resolution processes.

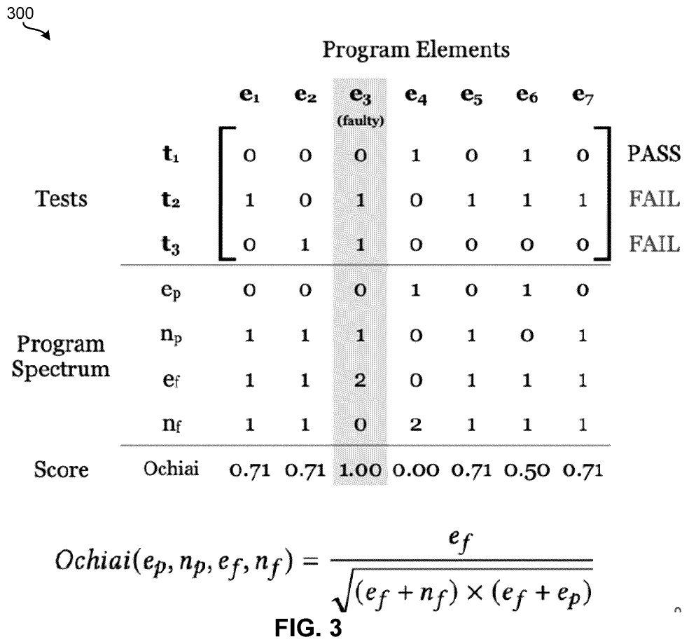

FIG. 3 illustrates a diagram for spectrum-based fault localization. Spectrum-Based Fault Localization (SBFL) is a technique used to identify the parts of a program that are most likely responsible for a failure. It does this by analyzing execution traces of both passing and failing test cases to compute a suspiciousness score for each code component (e.g., statements, functions, or blocks).

SBFL operates in three main steps. The first step can include collecting execution data (program spectrum). A program can be executed multiple times with different test cases. For each test case, execution data (or program spectrum) is collected, showing which parts of the code were executed. Each test case can be classified as passing (success) or failing (error).

FIG. 3 illustrates a SBFL matrix 300 that includes seven exemplary program elements (e₁, e₂, e₃, e₄, e₅, e₆, e₇). The program elements can a source file name, a function, a component of the system, or a single line of source code. There are three exemplary tests run (t₁, t₂, t₃). The results of each of the tests (e.g., pass or fail) can be entered in the matrix for each of the program elements. The coverage matrix, represented by ones and zeros, included whether or not that test covers or executed that part of the task. A one indicates that the task was executed and a zero indicates that it was not during that test. For example, in test t₁ program elements e₄ and e₆ were executed and test elements e₁, e₂, e₃, and es were not executed.

Next, the SBFL process can include computing a suspiciousness score. Using the collected execution data, suspiciousness scores are computed for each code component. The score is based on how often a component appears in failing vs. passing test cases. Common formulas for suspiciousness include can include Tarantula. Ochiai, Jaccard, and D Star, each with slight variations in how they weigh failing vs. passing executions.

### Tarantula Formula:

$$S ( c ) = \frac{\frac{f c}{F}}{\frac{f c}{F} + \frac{p c}{P}}$$

where S(c) is suspiciousness score of component c. f_{c} us the number of failing test cases that executed c. p_{c} is the number of passing test cases that executed c. F is the total number of failing test cases. P is the total number of passing test cases.

### Ochiai Formula 1:

$$S ( c ) = \frac{f c}{\sqrt{( f c + p c ) \times F}}$$

where S(c) is suspiciousness score of component c. f_{c} us the number of failing test cases that executed c. p_{c} is the number of passing test cases that executed c. F is the total number of failing test cases.

If a code component appears only in failing test cases, its score is higher, meaning it is more suspicious. If a code component appears in both failing and passing cases, the score is lower, meaning it is less likely to be the cause of failure. The denominator normalizes the score to avoid bias due to code that is frequently executed.

### Ochiai Formula 2:

$$S ( c ) = \frac{e f}{\sqrt{( e f + n f ) \times ( e f + e p )}}$$

where ep is a number of passing test cases that covered the program element; np is a number of passing test cases that did not cover the program element; ef is a number of failing test cases that covered the program element; and nf is a number of failing test cases that did not cover the program element.

Other localization techniques can also be used such as but not limited to mutation-based fault location which applies some kind of code mutation in the code base and then sees if certain mutations within the code have similar symptoms.

Localizing the source for crash issues can be challenging due to the limited information available. When a crash occurs, it may be possible to capture the state information. Crash issues can be traced by parsing crash dumps to extract call stacks, register values, and memory information to identify null pointer references or failed assertions. Call stacks can be a series of function calls. The system can identify the crash issue based on null point references or failed assertions.

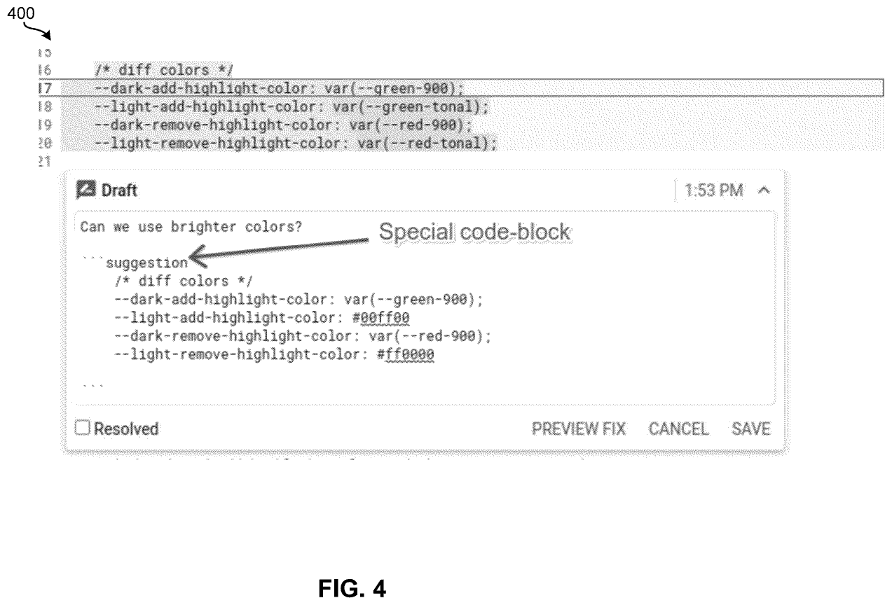

FIG. 4 illustrates an exemplary developer review user interface 400 including special code block or code snippet. This developer review example can be made in one of several code review systems. One such example is Gerritt. Gerrit is a web-based code review tool developed by Google that integrates with Git. It is commonly used in software development workflows to facilitate code collaboration, ensuring that changes are reviewed before being merged into the main codebase.

Another example code review system is GitHub. GitHub is a cloud-based platform for version control and collaboration, primarily used for software development. It allows developers to host, manage, and share code using Git, a distributed version control system. In the GitHub, a developer can make a pull request that allows a developer to do a code review and input developer comments.

The exemplary code block is an example of developer inputs/feedback for editing the code. Clicking “Suggest Fix” will insert a special code-block in the text of the comment. The contents of this code block will replace the lines the comment is attached to (what gets highlighted when hovering over comment). This can be done using HTTP APIs. While a developer can make these kinds of suggestions, the techniques can have a LLM generate a patch and make these types of comments or suggestions. Further, a human developer may see this comment and through a UI decide whether or not to apply the fix or not. In addition, the human developer may provide input and reply to the comments or suggestions. The developer input can then be used for another iteration of the patch generation.

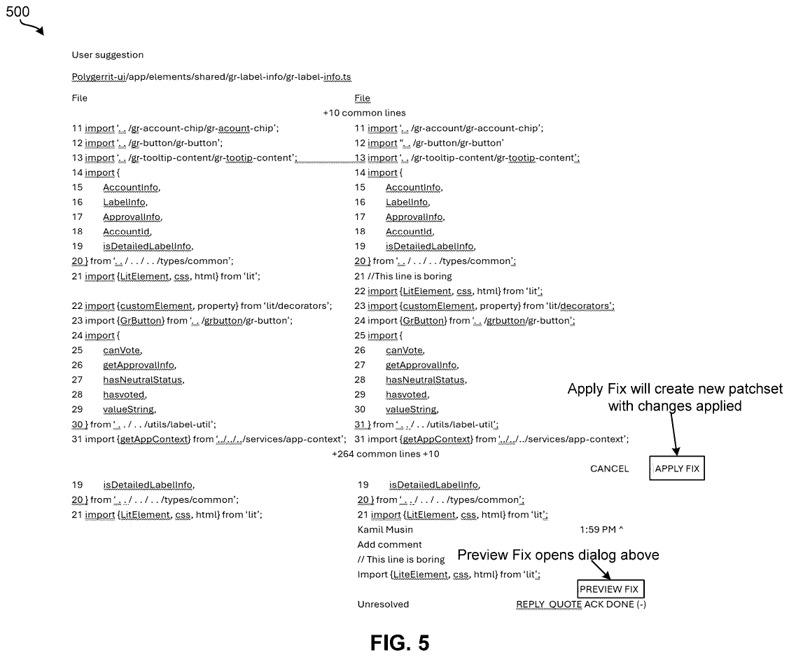

FIG. 5 illustrates an exemplary user interface 500 for a developer to preview a fix. In various embodiments, the “preview fix” button can display the fix for the developer. The user interface 500 can allow a developer to apply the fix by selecting the “APPLY FIX” option.

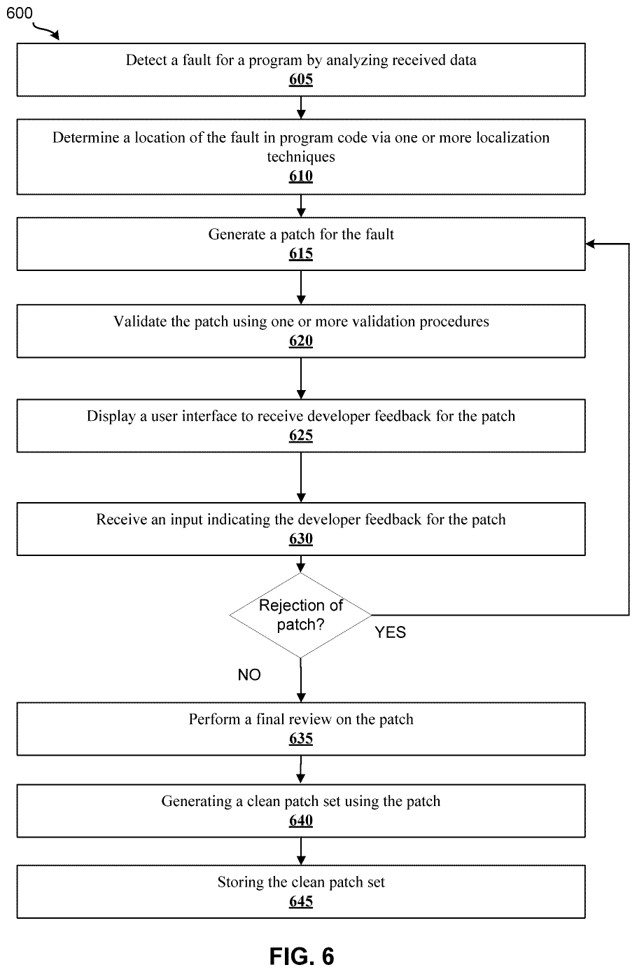

FIG. 6 is a flowchart of an example process 600 for techniques for automatic program repair integrated into code system review system using LLMs. In some implementations, one or more process blocks of FIG. 6 may be performed by a computing device.

As also shown in FIG. 6, at block 605 process 600 may include detecting a fault for a program by analyzing received data. For example, the computing device may include detecting a fault for a program by analyzing received data. In various embodiments, the received data comprises at least one of build logs, test results, crash reports, or execution logs.

As also shown in FIG. 6, at block 610 process 600 may include determining a location of the fault in the program code via one or more localization techniques. For example, the computing device may include determining a location of the fault in program code via one or more localization techniques. In various embodiments, the location of the fault is determined by one of more of: reviewing compiler warnings, localizing test failures, and parsing crash dumps to extract call stacks, register values, and memory information to identify null pointer references or failed assertions. In various embodiments, the localizing test failures is accomplished via spectrum-based fault localization process.

As also shown in FIG. 6, at block 615 process 600 may include generating a first patch for the fault. For example, the computing device may include generating a first patch for the fault. In various embodiments, the generating the first patch or the second patch includes using language server protocol features to collect context about the fault. Generating the first patch or the second patch can include extracting relevant code structures using tree-sitter parsing techniques. Generating the first patch or the second patch can include generating a fix using a large language model agent to analyze one or more of the context about the fault, the extracted relevant code structures, fault type, and relevant project-specific patterns.

As also shown in FIG. 6, at block 620 process 600 may include validating the first patch using one or more validation procedures. For example, the computing device may include validating the first patch using one or more validation procedures. The process 600 can use LSP diagnostics for compiler warnings, or test pass/failure results in CI process, etc. Validating a patch using large language models (LLMs) involves leveraging their ability to understand code, detect anomalies, and assess semantic correctness. A patch typically consists of a diff or code change (e.g., git diff format). A first step can include preparing the patch by extracting content by parsing the changed files, extracting surrounding code (before and after the change) to provide context, and identifying function/class boundaries or dependencies affected.

A LLM can be used for static validation using a series of prompts to understand the intent of the patch, checking for syntax and style, detecting bugs or anomalies, and assessing sematic correctness.

Although LLMs can't execute code, they can generate test cases for changed functions and infer edge cases introduced by the patch. LLM outputs can be integrated into pull request review pipelines for auto-commenting on risky changes, flagging missing tests or documentation, and suggesting improvements.

Developers can review LLM-generated insights. LLMs can summarize concerns or give decision-support, not final approvals.

As also shown in FIG. 6, at block 625 process 600 may include displaying a user interface to receive developer feedback for the first patch. For example, the computing device may include displaying a user interface to receive developer feedback for the first patch.

As also shown in FIG. 6, at block 630 process 600 may include receiving a first input indicating the developer feedback for the first patch. For example, the computing device may include receiving a first input indicating the developer feedback for the first patch.

If the first input indicates rejection of the first patch, at block 630 process 600 may include receiving developer feedback regarding the first patch. For example, the computing device may include receiving developer feedback regarding the first patch.

As also shown in FIG. 6, at block 615 process 600 may include generating a second patch in view of the developer feedback regarding the first patch. For example, the computing device may include generating a second patch in view of the developer feedback regarding the first patch.

As also shown in FIG. 6, at block 620 process 600 may include validating the second patch using one or more validation procedures. For example, the computing device may include validating the second patch using one or more validation procedures. In various embodiments, the one or more validation procedures include one or more of reviewing language server protocol diagnostics, secondary test results, or secondary crash issues.

As also shown in FIG. 6, at block 625 process 600 may include displaying the user interface to receive developer feedback for the second patch. For example, the computing device may include displaying the user interface to receive developer feedback for the second patch.

As also shown in FIG. 6, at block 630 process 600 may include receiving second input indicating the developer feedback for the second patch. For example, the computing device may include receiving second input indicating the developer feedback for the second patch.

If the first input or the second input indicates an approval of the first patch or the second patch, at block 635 process 600 may include performing a final review on the first patch or the second patch. For example, the computing device may include performing a final review on the first patch or the second patch.

As also shown in FIG. 6, at block 640 process 600 may include generating a clean patch set using the first patch or the second patch. For example, the computing device may include generating a clean patch set using the first patch or the second patch.

In various embodiments, the generating the clean patch set can include removing explanatory comments, verifying all temporary debugging code, TODOs, or non-production elements are removed, and conducting automated checks to ensure that the clean patch set maintains a consistent coding style, adheres to project conventions, and does not introduce new issues.

As also shown in FIG. 6, at block 645 process 600 may include storing the clean patch set. For example, the computing device may include storing the clean patch set.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

While the proposed invention shares some similarities with existing solutions, such as the commercial service “Devin,” which is known as an AI software engineer, there are several key differences and advantages that set this invention apart.

The disclosed techniques provide a proactive approach. Unlike Devin, which relies on user input through a chat interface, the proposed invention takes a proactive approach to tackle software bug issues. The AI-based agent actively monitors the bug report system and initiates its tasks independently, without requiring explicit user invocation. This proactive approach allows for faster and more efficient bug resolution, as the agent can start working on bugs as soon as they are reported.

The disclosed techniques provide a seamless integration with development workflow. The proposed techniques seamlessly integrate into the existing development workflow, minimizing disruption to developers' daily routines. By leveraging the code review system and asynchronous communication channels, the agent's actions blend naturally into the developers' normal work processes. Developers can provide feedback and guidance to the agent through the familiar code review interface, making the interaction more intuitive and less intrusive compared to a separate chat interface.

The disclosed techniques can provide minimized developer communication. The techniques aim to minimize the communication overhead between developers and the AI-based agent. By providing detailed reasoning and insights within the code review system, the agent reduces the need for extensive back-and-forth communication. Developers can review the agent's findings and provide feedback directly within the code review platform, streamlining the collaboration process.

The disclosed techniques provide enhanced fault localization and fix generation. The proposed techniques leverage advanced techniques, such as Language Server Protocol (LSP) features and code navigation capabilities, to enhance fault localization and fix generation. The agent can thoroughly analyze the codebase, identify potential fault locations, and generate fixes based on its reasoning and insights. This comprehensive approach aims to improve the accuracy and effectiveness of the automated bug resolution process.

The disclosed techniques can provide continuous improvement through feedback. The disclosed techniques can incorporate a feedback loop that allows the agent to learn and improve its performance over time. By considering the feedback provided by developers during the code review process, the agent can refine its reasoning, fault localization, and fix generation capabilities. This continuous improvement ensures that the agent becomes more accurate and efficient as it processes more bug reports and interacts with developers.

In summary, while the proposed invention shares the concept of an AI-based agent assisting in software development tasks, it differentiates itself through its proactive approach, seamless integration with the development workflow, minimized developer communication, enhanced fault localization and fix generation capabilities, and continuous improvement through feedback. These advantages aim to provide a more efficient, effective, and developer-friendly solution for automating bug resolution in software projects.

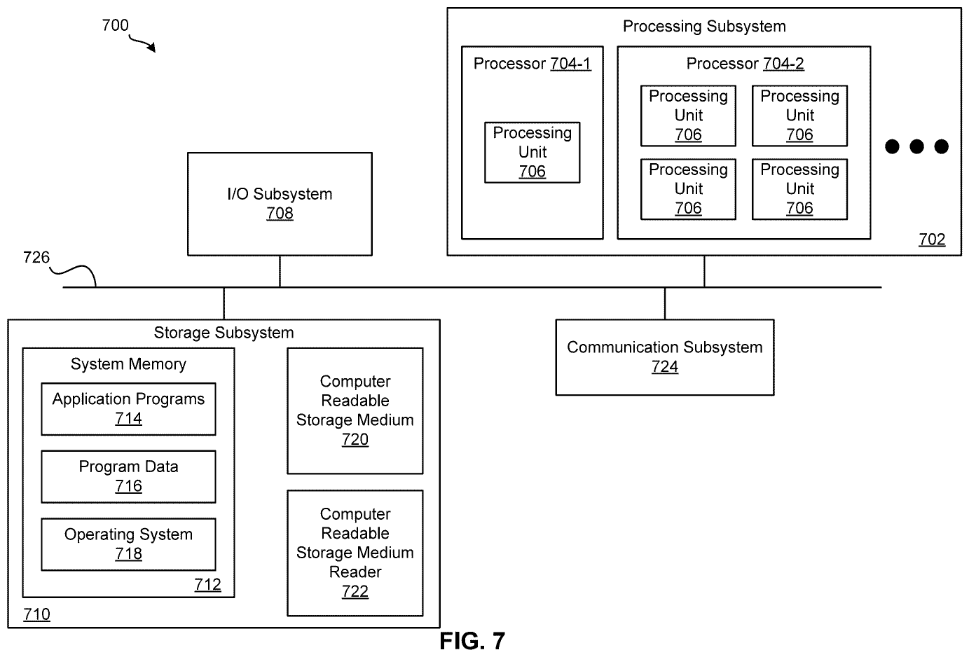

FIG. 7 illustrates a computer system 700 for implementing various embodiments described above. Computer system 700 may be a desktop computer, a laptop, a server computer, or any other type of computer system or combination thereof. In addition, computer system 700 can implement many of the operations, methods, and/or processes described above (e.g., process 600). As shown in FIG. 7, computer system 700 includes processing subsystem 702, which communicates via bus subsystem 726, with input/output (I/O) subsystem 708, storage subsystem 710 and communication subsystem 724.

Bus subsystem 726 is configured to facilitate communication among the various components and subsystems of computer system 700. While bus subsystem 726 is illustrated in FIG. 7 as a single bus, one of the ordinary skill in the art will understand that bus subsystem 726 may be implemented as multiple buses. Bus subsystem 726 may be any of several types of bus structures (e.g., a memory bus or memory controller, a peripheral bus, a local bus, etc.) using any of a variety of bus architectures. Examples of bus architecture may include an Industry Standard Architecture (ISA) bus, a Micro Channel Architecture (MCA) bus, an Extended ISA (EISA) bus, a Video Electronics Standards Association (VESA) local bus, a Peripheral Component Interconnect (PCI) bus, a Universal Serial Bus (USB), etc.

Processing subsystem 702, which can be implemented as one or more integrated circuits (e.g., a conventional microprocessor or microcontroller), controls the operation of computer system 700. Processing subsystem 702 may include one or more processors 704. Each processor 704 may include one processing unit 706 (e.g., a single core processor such as processor 704-1) or several processing units 706 (e.g., a multicore processor such as processor 704-2). In some embodiments, processors 704 of processing subsystem 702 may be implemented as independent processors while, in other embodiments, processors 704 of processing subsystem 702 may be implemented as multiple processors integrate into a single chip or multiple chips. Still, in some embodiments, processors 704 of processing subsystem 702 may be implemented as a combination of independent processors and multiple processors integrated into a single chip or multiple chips.

In some embodiments, processing subsystem 702 can execute a variety of programs or processes in response to program code and can maintain multiple concurrently executing programs or processes. At any given time, some or all of the program code to be executed can reside in processing subsystem 702 and/or in storage subsystem 710. Through suitable programming, processing subsystem 702 can provide various functionalities, such as the functionalities described above by reference to process 600.

I/O subsystem 708 may include any number of user interface input devices and/or user interface output devices. User interface input devices may include a keyboard, pointing devices (e.g., a mouse, a trackball, etc.), a touchpad, a touch screen incorporated into a display, a scroll wheel, a click wheel, a dial, a button, a switch, a keypad, audio input devices with voice recognition systems, microphones, image/video capture devices (e.g., webcams, image scanners, barcode readers, etc.), motion sensing devices, gesture recognition devices, eye gesture (e.g., blinking) recognition devices, biometric input devices, and/or any other types of input devices.

User interface output devices may include visual output devices (e.g., a display subsystem, indicator lights, etc.), audio output devices (e.g., speakers, headphones, etc.), etc. Examples of a display subsystem may include a cathode ray tube (CRT), a flat-panel device (e.g., a liquid crystal display (LCD), a plasma display, etc.), a projection device, a touch screen, and/or any other types of devices and mechanisms for outputting information from computer system 700 to a user or another device (e.g., a printer).

As illustrated in FIG. 7, storage subsystem 710 includes system memory 712, computer-readable storage medium 720, and computer-readable storage medium reader 722. System memory 712 may be configured to store software in the form of program instructions that are loadable and executable by processing subsystem 702 as well as data generated during the execution of program instructions. In some embodiments, system memory 712 may include volatile memory (e.g., random access memory (RAM)) and/or non-volatile memory (e.g., read-only memory (ROM), programmable read-only memory (PROM), erasable programmable read-only memory (EPROM), electrically erasable programmable read-only memory (EEPROM), flash memory, etc.). System memory 712 may include several types of memory, such as static random-access memory (SRAM) and/or dynamic random-access memory (DRAM). System memory 712 may include a basic input/output system (BIOS), in some embodiments, which is configured to store basic routines to facilitate transferring information between elements within computer system 700 (e.g., during start-up). Such a BIOS may be stored in ROM (e.g., a ROM chip), flash memory, or any other type of memory that may be configured to store the BIOS.

As shown in FIG. 7, system memory 712 includes application programs 714, program data 716, and operating system (OS) 718. OS 718 may be one of various versions of Microsoft Windows, Apple Mac OS, Apple OS X, Apple macOS, and/or Linux operating systems, a variety of commercially-available UNIX or UNIX-like operating systems (including without limitation the variety of GNU/Linux operating systems, the Google Chrome® OS, and the like) and/or mobile operating systems such as Apple IOS, Windows Phone, Windows Mobile, Android, BlackBerry OS, Blackberry 10, and Palm OS, WebOS operating systems.

Computer-readable storage medium 720 may be a non-transitory computer-readable medium configured to store software (e.g., programs, code modules, data constructs, instructions, etc.). Many of the components and/or processes (e.g., process 600) described above may be implemented as software that when executed by a processor or processing unit (e.g., a processor or processing unit of processing subsystem 702) performs the operations of such components and/or processes. Storage subsystem 710 may also store data used for, or generated during, the execution of the software.

Storage subsystem 710 may also include computer-readable storage medium reader 722 that is configured to communicate with computer-readable storage medium 720. Together and optionally, in combination with system memory 712, computer-readable storage medium 720 may comprehensively represent remote, local, fixed, and/or removable storage devices plus storage media for temporarily and/or more permanently containing, storing, transmitting, and retrieving computer-readable information.

Computer-readable storage medium 720 may be any appropriate media known or used in the art, including storage media such as volatile, non-volatile, removable, non-removable media implemented in any method or technology for storage and/or transmission of information. Examples of such storage media includes RAM, ROM, EEPROM, flash memory or other memory technology, compact disc read-only memory (CD-ROM), digital versatile disk (DVD), Blu-ray Disc (BD), magnetic cassettes, magnetic tape, magnetic disk storage (e.g., hard disk drives), Zip drives, solid-state drives (SSDs), flash memory card (e.g., secure digital (SD) cards, CompactFlash cards, etc.), USB flash drives, or any other type of computer-readable storage media or device.

Communication subsystem 724 serves as an interface for receiving data from, and transmitting data to other devices, computer systems, and networks. For example, communication subsystem 724 may allow computer system 700 to connect to one or more devices via a network (e.g., a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.). Communication subsystem 724 can include any number of different communication components. Examples of such components may include radio frequency (RF) transceiver components for accessing wireless voice and/or data networks (e.g., using cellular technologies such as 2G, 3G, 4G, 5G, etc., wireless data technologies such as Wi-Fi, Bluetooth, ZigBee, etc., or any combination thereof), global positioning system (GPS) receiver components, and/or other components. In some embodiments, communication subsystem 724 may provide components configured for wired communication (e.g., Ethernet) in addition to or instead of components configured for wireless communication.

One of the ordinary skill in the art will realize that the architecture shown in FIG. 7 is only an example architecture of computer system 700, and that computer system 700 may have additional or fewer components than shown, or a different configuration of components. The various components shown in FIG. 7 may be implemented in hardware, software, firmware, or any combination thereof, including one or more signal processing and/or application specific integrated circuits.

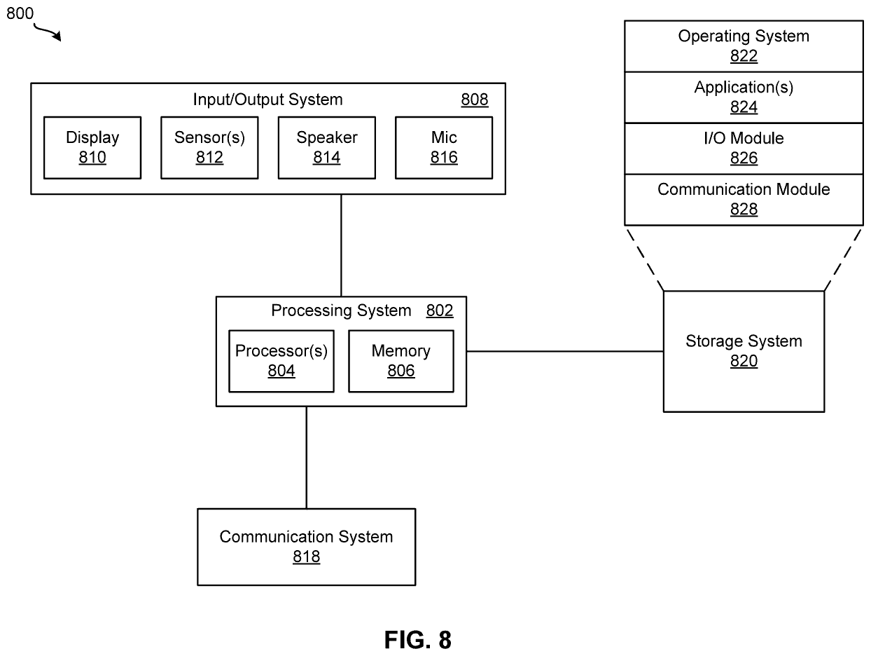

FIG. 8 illustrates an exemplary computing device 800 for implementing various embodiments described above. Computing device 800 may be a cellphone, a smartphone, a wearable device, an activity tracker or manager, a tablet, a personal digital assistant (PDA), a media player, or any other type of mobile computing device or combination thereof. In addition, computing device 800 can implement many of the operations, methods, and/or processes described above (e.g., process 600). As shown in FIG. 8, computing device 800 includes processing system 802, input/output (I/O) system 808, communication system 818, and storage system 820. These components may be coupled by one or more communication buses or signal lines.

Processing system 802, which can be implemented as one or more integrated circuits (e.g., a conventional microprocessor or microcontroller), controls the operation of computing device 800. As shown, processing system 802 includes one or more processors 804 and memory 806. Processors 804 are configured to run or execute various software and/or sets of instructions stored in memory 806 to perform various functions for computing device 800 and to process data.

Each processor of processors 804 may include one processing unit (e.g., a single core processor) or several processing units (e.g., a multicore processor). In some embodiments, processors 804 of processing system 802 may be implemented as independent processors while, in other embodiments, processors 804 of processing system 802 may be implemented as multiple processors integrated into a single chip. Still, in some embodiments, processors 804 of processing system 802 may be implemented as a combination of independent processors and multiple processors integrated into a single chip.

Memory 806 may be configured to receive and store software (e.g., operating system 822, applications 824, I/O module 826, communication module 828, etc. from storage system 820) in the form of program instructions that are loadable and executable by processors 804 as well as data generated during the execution of program instructions. In some embodiments, memory 806 may include volatile memory (e.g., random access memory (RAM)), non-volatile memory (e.g., read-only memory (ROM), programmable read-only memory (PROM), erasable programmable read-only memory (EPROM), electrically erasable programmable read-only memory (EEPROM), flash memory, etc.), or a combination thereof.

I/O system 808 is responsible for receiving input through various components and providing output through various components. As shown for this example, I/O system 808 includes display 810, one or more sensors 812, speaker 814, and microphone 816. Display 810 is configured to output visual information (e.g., a graphical user interface (GUI) generated and/or rendered by processors 804). In some embodiments, display 810 is a touch screen that is configured to also receive touch-based input. Display 810 may be implemented using liquid crystal display (LCD) technology, light-emitting diode (LED) technology, organic LED (OLED) technology, organic electro luminescence (OEL) technology, or any other type of display technologies. Sensors 812 may include any number of several types of sensors for measuring a physical quantity (e.g., temperature, force, pressure, acceleration, orientation, light, radiation, etc.). Speaker 814 is configured to output audio information and microphone 816 is configured to receive audio input. One of the ordinary skill in the art will appreciate that I/O system 808 may include any number of additional, fewer, and/or different components. For instance, I/O system 808 may include a keypad or keyboard for receiving input, a port for transmitting data, receiving data and/or power, and/or communicating with another device or component, an image capture component for capturing photos and/or videos, etc.

Communication system 818 serves as an interface for receiving data from, and transmitting data to, other devices, computer systems, and networks. For example, communication system 818 may allow computing device 800 to connect to one or more devices via a network (e.g., a personal area network (PAN), a local area network (LAN), a storage area network (SAN), a campus area network (CAN), a metropolitan area network (MAN), a wide area network (WAN), a global area network (GAN), an intranet, the Internet, a network of any number of different types of networks, etc.). Communication system 818 can include any number of different communication components. Examples of such components may include radio frequency (RF) transceiver components for accessing wireless voice and/or data networks (e.g., using cellular technologies such as 2G, 3G, 4G, 5G, etc., wireless data technologies such as Wi-Fi, Bluetooth, ZigBee, etc., or any combination thereof), global positioning system (GPS) receiver components, and/or other components. In some embodiments, communication system 818 may provide components configured for wired communication (e.g., Ethernet) in addition to or instead of components configured for wireless communication.

Storage system 820 handles the storage and management of data for computing devices 800. Storage system 820 may be implemented by one or more non-transitory machine-readable mediums that are configured to store software (e.g., programs, code modules, data constructs, instructions, etc.) and store data used for, or generated during, the execution of the software. Many of the components and/or processes (e.g., process 600) described above may be implemented as software that when executed by a processor or processing unit (e.g., processors 804 of processing system 802) perform the operations of such components and/or processes.

In this example, storage system 820 includes operating system 822, one or more applications 824, I/O module 826, and communication module 828. Operating system 822 includes various procedures, sets of instructions, software components and/or drivers for controlling and managing general system tasks (e.g., memory management, storage device control, power management, etc.) and facilitates communication between various hardware and software components. Operating system 822 may be one of various versions of Microsoft Windows, Apple Mac OS, Apple OS X, Apple macOS, and/or Linux operating systems, a variety of commercially-available UNIX or UNIX-like operating systems (including without limitation the variety of GNU/Linux operating systems, the Google Chrome® OS, and the like) and/or mobile operating systems such as Apple IOS, Windows Phone, Windows Mobile, Android, BlackBerry OS, Blackberry 10, and Palm OS, WebOS operating systems.

Applications 824 can include any number of different applications installed on computing device 800. Examples of such applications may include a browser application, an address book application, a contact list application, an email application, an instant messaging application, a word processing application, JAVA-enabled applications, an encryption application, a digital rights management application, a voice recognition application, location determination application, a mapping application, a music player application, etc.

I/O module 826 manages information received via input components (e.g., display 810, sensors 812, and microphone 816) and information to be outputted via output components (e.g., display 810 and speaker 814). Communication module 828 facilitates communication with other devices via communication system 818 and includes various software components for handling data received from communication system 818.

One of ordinary skill in the art will realize that the architecture shown in FIG. 8 is only an example architecture of computing device 800, and that computing device 800 may have additional or fewer components than shown, or a different configuration of components. The various components shown in FIG. 8 may be implemented in hardware, software, firmware, or any combination thereof, including one or more signal processing and/or application specific integrated circuits.

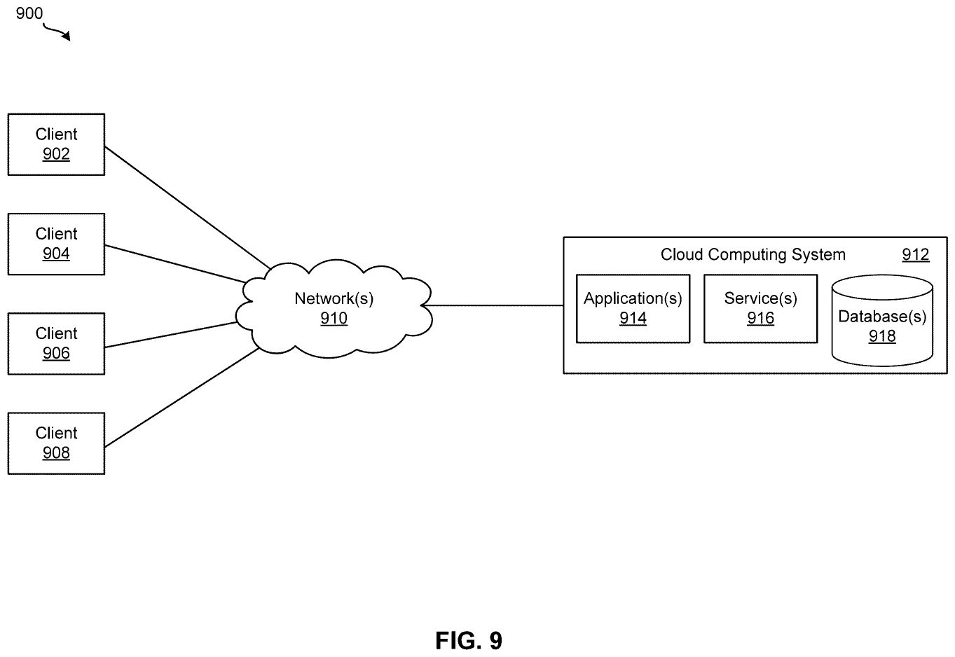

FIG. 9 illustrates an exemplary system 900 for implementing various embodiments described above. For example, any client devices 902, 904, 906, 908 may be used to implement the cloud computing system 912. As shown, system 900 includes client devices 902, 904, 906, and 908, one or more networks 910, and cloud computing system 912. Cloud computing system 912 is configured to provide resources and data to client devices 902, 904, 906, and 908 via networks 910. In some embodiments, cloud computing system 912 provides resources to any number of different users (e.g., customers, tenants, organizations, etc.). Cloud computing system 912 may be implemented by one or more computer systems (e.g., servers), virtual machines operating on a computer system, or a combination thereof.

As shown, cloud computing system 912 includes one or more applications 914, one or more services 916, and one or more databases 918. Cloud computing system 912 may provide applications 914, services 916, and databases 918 to any number of different customers in a self-service, subscription-based, elastically scalable, reliable, highly available, and secure manner.

In some embodiments, cloud computing system 912 may be adapted to automatically provision, manage, and track a customer's subscriptions to services offered by cloud computing system 912. Cloud computing system 912 may provide cloud services via different deployment models. For example, cloud services may be provided under a public cloud model in which cloud computing system 912 is owned by an organization selling cloud services and the cloud services are made available to the public or different industry enterprises. As another example, cloud services may be provided under a private cloud model in which cloud computing system 912 is operated solely for a single organization and may provide cloud services for one or more entities within the organization. The cloud services may also be provided under a community cloud model in which cloud computing system 912 and the cloud services provided by cloud computing system 912 are shared by several organizations in a related community. The cloud services may also be provided under a hybrid cloud model, which is a combination of two or more of the aforementioned different models.

In some instances, any one of applications 914, services 916, and databases 918 made available to client devices 902, 904, 906, and 908 via networks 910 from cloud computing system 912 is referred to as a “cloud service.” Typically, servers and systems that make up cloud computing system 912 are different from the on-premises servers and systems of a customer. For example, cloud computing system 912 may host an application and a user of one of client devices 902-908 may order and use the application via networks 910.

Applications 914 may include software applications that are configured to execute on cloud computing system 912 (e.g., a computer system or a virtual machine operating on a computer system) and be accessed, controlled, managed, etc. via client devices 902-908. In some embodiments, applications 914 may include server applications and/or mid-tier applications (e.g., HTTP (hypertext transfer protocol) server applications, FTP (file transfer protocol) server applications, CGI (common gateway interface) server applications, JAVA server applications, etc.). Services 916 are software components, modules, applications, etc. that are configured to execute on cloud computing system 912 and provide functionalities to client devices 902-908 via networks 910. Services 916 may be web-based services or on-demand cloud services.

Databases 918 are configured to store and/or manage data that is accessed by applications 914, services 916, and/or client devices 902-908. For instance, the customer sales data may be stored in databases 918. Databases 918 may reside on a non-transitory storage medium local to (and/or resident in) cloud computing system 912, in a storage-area network (SAN), on a non-transitory storage medium local located remotely from cloud computing system 912. In some embodiments, databases 918 may include relational databases that are managed by a relational database management system (RDBMS). Databases 918 may be a column-oriented databases, row-oriented databases, or a combination thereof. In some embodiments, some or all of databases 918 are in-memory databases. That is, in some such embodiments, data for databases 918 are stored and managed in memory (e.g., random access memory (RAM)).

Client devices 902-908 are configured to execute and operate a client application (e.g., a web browser, a proprietary client application, etc.) that communicates with applications 914, services 916, and/or databases 918 via networks 910. This way, client devices 902-908 may access the various functionalities provided by applications 914, services 916, and databases 918 while applications 914, services 916, and databases 918 are operating (e.g., hosted) on cloud computing system 912. Although system 900 is shown with four client devices, any number of client devices may be supported.

Networks 910 may be any type of network configured to facilitate data communications among client devices (e.g., first client device 902, second client device 904, third client device 906, and fourth client device 908) and cloud computing system 912 using any of a variety of network protocols. Networks 910 may be a personal area network (PAN), a local area network (LAN), a storage area network (SAN), a campus area network (CAN), a metropolitan area network (M A N), a wide area network (WAN), a global area network (GAN), an intranet, the Internet, a network of any number of different types of networks, etc.

The above description illustrates various embodiments of the present disclosure along with examples of how aspects of the present disclosure may be implemented. The above examples and embodiments should not be deemed to be the only embodiments and are presented to illustrate the flexibility and advantages of various embodiments of the present disclosure as defined by the following claims. Based on the above disclosure and the following claims, other arrangements, embodiments, implementations, and equivalents will be evident to those skilled in the art and may be employed without departing from the spirit and scope of the present disclosure as defined by the claims.

The foregoing disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting the implementations. Thus, the operation and behavior of the systems and/or methods are described herein without reference to specific software code—it being understood that software and hardware can be used to implement the systems and/or methods based on the description herein. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or” unless explicitly stated otherwise (e.g., if used in combination with “either” or “only one of”).

What is claimed is:

1. A computer implemented method comprising:
detecting a fault for a program by analyzing received data;
determining a location of the fault in program code via one or more localization techniques;
generating a first patch for the fault;
validating the first patch using one or more validation procedures;
displaying a user interface to receive developer feedback for the first patch;
receiving a first input indicating the developer feedback for the first patch;
if the first input indicates rejection of the first patch:
receiving developer feedback regarding the first patch;
generating a second patch in view of the developer feedback regarding the first patch;
validating the second patch using one or more validation procedures;
displaying the user interface to receive developer feedback for the second patch;
receiving second input indicating the developer feedback for the second patch;
if the first input or the second input indicates an approval of the first patch or the second patch:
performing a final review on the first patch or the second patch;
generating a clean patch set using the first patch or the second patch; and
storing the clean patch set.

2. The computer implemented method of claim 1 wherein the received data comprises at least one of build logs, test results, crash reports, or execution logs.

3. The computer implemented method of claim 2 wherein the location of the fault is determined by one of more of: reviewing compiler warnings, localizing test failures, and parsing crash dumps to extract call stacks, register values, and memory information to identify null pointer references or failed assertions.

4. The computer implemented method of claim 3 wherein the localizing test failures is accomplished via spectrum-based fault localization process.

5. The computer implemented method of claim 1, wherein the generating the first patch or the second patch comprises:
using language server protocol features to collect context about the fault;
extracting relevant code structures using tree-sitter parsing techniques; and
generating a fix using a large language model agent to analyze one or more of the context about the fault, the extracted relevant code structures, fault type, and relevant project-specific patterns.

6. The computer implemented method of claim 1, wherein the one or more validation procedures comprises one or more of reviewing language server protocol diagnostics, secondary test results, or secondary crash issues.

7. The computer implemented method of claim 1, wherein the generating the clean patch set comprises:
removing explanatory comments;
verifying all temporary debugging code, TODOs, or non-production elements are removed; and
conducting automated checks to ensure that the clean patch set maintains a consistent coding style, adheres to project conventions, and does not introduce new issues.

8. A non-transitory computer-readable medium storing a set of instructions, that, when executed by one or more processors of a device, cause the device to perform operations comprising:
detecting a fault for a program by analyzing received data;
determining a location of the fault in program code via one or more localization techniques;
generating a first patch for the fault;
validating the first patch using one or more validation procedures;
displaying a user interface to receive developer feedback for the first patch;
receiving a first input indicating the developer feedback for the first patch;
if the first input indicates rejection of the first patch:
receiving developer feedback regarding the first patch;
generating a second patch in view of the developer feedback regarding the first patch;
validating the second patch using one or more validation procedures;
displaying the user interface to receive developer feedback for the second patch;
receiving second input indicating the developer feedback for the second patch;
if the first input or the second input indicates an approval of the first patch or the second patch:
performing a final review on the first patch or the second patch;
generating a clean patch set using the first patch or the second patch; and
storing the clean patch set.

9. The non-transitory computer-readable medium of claim 8, wherein the received data comprises at least one of build logs, test results, crash reports, or execution logs.

10. The non-transitory computer-readable medium of claim 9, wherein the location of the fault is determined by one of more of: reviewing compiler warnings, localizing test failures, and parsing crash dumps to extract call stacks, register values, and memory information to identify null pointer references or failed assertions.

11. The non-transitory computer-readable medium of claim 10, wherein the localizing test failures is accomplished via spectrum-based fault localization process.

12. The non-transitory computer-readable medium of claim 8, wherein the generating the first patch or the second patch comprises:
using language server protocol features to collect context about the fault;
extracting relevant code structures using tree-sitter parsing techniques; and
generating a fix using a large language model agent to analyze one or more of the context about the fault, the extracted relevant code structures, fault type, and relevant project-specific patterns.

13. The non-transitory computer-readable medium of claim 8, wherein the one or more validation procedures comprises one or more of reviewing language server protocol diagnostics, secondary test results, or secondary crash issues.

14. The non-transitory computer-readable medium of claim 8, wherein the generating the clean patch set comprises:
removing explanatory comments;
verifying all temporary debugging code, TODOs, or non-production elements are removed; and
conducting automated checks to ensure that the clean patch set maintains a consistent coding style, adheres to project conventions, and does not introduce new issues.

15. A system comprising:
one or more processors configured to access code stored in a memory to perform operations comprising:
detecting a fault for a program by analyzing received data;
determining a location of the fault in program code via one or more localization techniques;
generating a first patch for the fault;
validating the first patch using one or more validation procedures;
displaying a user interface to receive developer feedback for the first patch;
receiving a first input indicating the developer feedback for the first patch;
if the first input indicates rejection of the first patch:
receiving developer feedback regarding the first patch;
generating a second patch in view of the developer feedback regarding the first patch;
validating the second patch using one or more validation procedures;
displaying the user interface to receive developer feedback for the second patch;
receiving second input indicating the developer feedback for the second patch;
if the first input or the second input indicates an approval of the first patch or the second patch:
performing a final review on the first patch or the second patch;
generating a clean patch set using the first patch or the second patch; and
storing the clean patch set.

16. The system of claim 15, wherein the received data comprises at least one of build logs, test results, crash reports, or execution logs.

17. The system of claim 16, wherein the location of the fault is determined by one of more of: reviewing compiler warnings, localizing test failures, and parsing crash dumps to extract call stacks, register values, and memory information to identify null pointer references or failed assertions.

18. The system of claim 17, wherein the localizing test failures is accomplished via spectrum-based fault localization process.

19. The system of claim 15, wherein the generating the first patch or the second patch comprises:
using language server protocol features to collect context about the fault;
extracting relevant code structures using tree-sitter parsing techniques; and
generating a fix using a large language model agent to analyze one or more of the context about the fault, the extracted relevant code structures, fault type, and relevant project-specific patterns.

20. The system of claim 15, wherein the generating the clean patch set comprises:
removing explanatory comments;
verifying all temporary debugging code, TODOs, or non-production elements are removed; and
conducting automated checks to ensure that the clean patch set maintains a consistent coding style, adheres to project conventions, and does not introduce new issues.
